(19) United States
(12) Patent Application Publication
(10) Pub. No.: US 2020/0360920 A1
(43) Pub. Date: Nov. 19, 2020

(54) DEVICE FOR THE AMBIENT-TEMPERATURE STORAGE OF BIOLOGICAL MATERIAL

(71) Applicant: L'ETAT FRANÇAIS REPRESENTÉ PAR LE MINISTÈRE DE L'INTÉRIEUR, ISSY-LES-MOULINEAUX (FR)

(72) Inventor: Sylvain HUBAC, CERGY (FR)

(21) Appl. No.: 16/967,153

(22) PCT Filed: Feb. 5, 2019
(86) PCT No.: PCT/FR2019/000016

§ 371 Date: Aug. 4, 2020

(30) Foreign Application Priority Data
Feb. 5, 2018 (FR) 1870121

(51) Int. Cl. B01L 3/00

(52) U.S. Cl. CPC B01L 3/508; B01L 3/545; B01L 2200/18; B01L 2300/021; B01L 2300/022; B01L 2300/126; B01L 2300/0609; B01L 2300/0832; B01L 2300/0858; B01L 2300/12; B01L 2300/042

(57) ABSTRACT

The present invention relates to a device for the ambient-temperature storage of biological material, comprising at least one container (1) formed by a base (5) and a side wall. The internal side wall of the container (1) comprises a means for maintaining a substrate, such as a ring (3), above and separate from the base of the container, said substrate being suitable for containing the biological material to be stored. The present invention also relates to a device for the ambient temperature storage of biological material, comprising an assembly (4) rigidly secured to a plurality of devices according to the invention, and a device for archiving biological materials, which can receive at least two assemblies (4) according to the invention. The present invention further relates to a method for storing biological material and a method for unarchiving biological material.

The present invention relates to a device for the ambient-temperature storage of biological material, comprising at least one container (1) formed by a base (5), said container (1) comprising, on its internal side wall, a means for maintaining a substrate above and separate from the base of the container, said substrate being suitable for containing said biological material to be stored. The present invention also relates to a device for the ambient-temperature storage of biological material comprising an assembly (4) secured to at least 2, preferably a multiple of 8, more preferably 96, 384, or 1536 devices according to the invention, and a device for archiving biological material, able to accommodate at least 2 assemblies (4) according to the invention. Lastly, the present invention relates to a for storing biological material and a method for unarchiving biological material.

The field of the invention in particular relates to the storage and archiving of biological materials.

At this time, there are two types of devices making it possible to store from several thousand to several million biological samples. Those making it possible to store them at negative temperatures and those making it possible to store them at ambient temperature.

The storage of samples at negative temperatures, which may reach freezing or even cryogenic conditions, requires complex infrastructure that is expensive to inspect and keep operational, and the implementation of which requires the use of qualified personnel, in particular in the application of strict procedures so as to avoid any risks of incidents that may alter the integrity of persons and samples. Furthermore, depending on the format of the container in which the samples are packaged in a unitary manner (5-50 ml tubes, 0.1-2 ml micro-tubes), the space necessary to store several thousand to several million samples is also a factor that may become limiting in the choice of this storage mode. In order to facilitate their preparation and reduce the surface area of the storage spaces, the samples may be packaged in microplates that have a format compatible with the SBS (Society of Biomolecular Screening) international format able to accommodate 96, 384 or 1536 samples. In this format, the samples of a same microplate, although individualized in a distinct location, are integral with one another. If it is necessary to reuse one sample among the others, all of the samples must undergo the thawing step so that it is possible to recover the sample of interest, then must be refrozen so that they may continue to be preserved. These successive freezing and thawing steps can damage the samples. In order to preserve their integrity, these samples must also be transported under the same conditions in which they are stored.

Storing the samples at ambient temperature makes it possible to eliminate the constraints related to damage of the samples due to the successive freezing/thawing steps, and does not require infrastructure that is complex to implement and maintain. According to this storage mode, the transport costs are also reduced. The costs of transporting the same sample at a negative temperature can be estimated at about 5 times higher than at ambient temperature. However, the technical process of preparing samples for storage can be fairly complex and may require outside services from industrial platforms with the appropriate know-how. This is in particular the case for services that may be offered by Imagene (France) in its method for long-term preservation of DNA molecules (patent EP 1,075,515 B1 (PCT/FR1998/000912 dated May 6, 1998). In this industrial method, the DNA is dehydrated, then preserved in a metal capsule, called DNAshell®, measuring 0.7 cm³, which is anhydrous, anoxic and tight. It is thus possible to preserve more than 60,000 samples in a surface area of about 1 m² and with a height of about 30 cm, or about 400,000 samples per 2 m³ (1 m² of floor space and 2 m high). Other technical solutions that are much simpler to implement are also commercially available. These are in particular the DNAStable® and DNAStable® LD solutions offered by Biomatricia (USA) (patent application US 20110081363 dated May 11, 2010) or the GenTegra-DNA® solution (WO2003040991 A2, U.S. Pat. No. 7,142,987 B2, U.S. Pat. No. 7,584,240 B2 GenVault Corporation) offered by GenTegra, which make it possible to preserve the DNA in dehydrated form. These solutions can thus be contained in unitary micro-tubes of 0.5 or 1.7 ml provided with or able to bear a stopper, but also in unitary micro-tubes of 0.3 or 0.75 ml that can be inserted into a microplate with 96 positions. In this microplate 96 format, the micro-tubes can bear an individual stopper, but more generally all of the samples are secured to one another at the end of the preservation process by affixing a film so as to ensure the tightness of the micro-tubes. The method for preserving the samples in dehydrated form consists of five steps:
1. adding a volume of DNA on the DNAStable® or GenTegra-DNA® solution;
2. homogenizing the solution using a micropipette;
3. drying for 4 to 72 hours at ambient temperature or 10 to 75 minutes using a concentrator as a function of the volume of DNA to be dehydrated;
4. closing the micro-tubes or sealing the microplate;
5. packaging in a drying cabinet making it possible to maintain a hygrometry <40% or packaging in a pouch containing desiccants in order to prevent rehydration of the sample.

The DNAStable® LD solution is packaged in liquid form. The method for preserving DNA samples using this solution also consists of five steps:
1. adding 20 μL of DNAStable® LD to 1-100 μL of DNA;
2. homogenizing the solution using a micropipette;
3. drying for 4 to 72 hours at ambient temperature or 10 to 75 minutes using a concentrator as a function of the volume of DNA to be dehydrated;
4. closing the micro-tube or sealing the microplate;
5. packaging in a drying cabinet making it possible to maintain a hygrometry <40% or packaging in a pouch containing desiccants in order to prevent rehydration of the sample.

As a comparison with the DNAshell® solution by Imagene, the DNAStable® solution in the 96 microplate format would make it possible to store about 57,000 samples per m2 over a height of about 30 cm, or about 380,000 samples per 2 m³ (1 m² of floor space and 2 m high). The DNA sample thus preserved by the DNAshell® (Imagene), DNAStable®/DNAStable® LD (Biomatricia) or GenTegra-DNA® (GenTegra) devices can be reused by simple rehydration with water.

Another method for preserving DNA at ambient temperature that is even simpler to implement is available in the form of sample cards. These are for example FTA® (patent application no. WO 1996039813 dated Jun. 7, 1996) or FTA® elute cards by General Electric (GE) (USA) and Nucleicard cards (patent application no. WO 2015019205 dated Aug. 7, 2013) by COPAN (Italy). As an example, the method for preserving DNA samples using the FTA® Elute solution consists of three steps:
1. depositing 25 μL of DNA on the card. If colored cards are used, this deposit will cause a discoloration of the card, thus making it possible to favor viewing of the deposition zone;
2. drying at ambient temperature for 3 hours;
3. packaging the card in a pouch containing desiccants in order to prevent rehydration of the sample.

However, although some of these cards have a format allowing them to be handled automatically, their large size of the order of 45 cm² (9 cm×5 cm) in this format requires a significant storage space. Indeed, at the end of their use, these cards are arranged in non-hermetic carriers with dimensions including the lid of the order of 12.5 cm L×9 cm W×6 cm H making it possible to house up to 20 cards. It can thus be estimated that it is possible to store about 7200 samples per m² over a height of about 30 cm, or about 48,000 samples per 2 m³ (1 m² of floor space and 2 m high). Although these cards have properties of preserving the integrity of the biomolecules over time, storing them at ambient temperature and atmospheric pressure tends to expose them to UV rays as well as the oxygen in the air, which are the main factors for the biological degradation of the DNA. To offset these effects and thus preserve the integrity of the samples over time, GE recommends storing these cards individually in hermetic envelopes in the presence of a desiccant in order to trap the humidity from the ambient air. These envelopes come in two formats: 9.5×7.5 cm (71.25 cm²) (reference WB100036) or 11×16.5 cm (181.5 cm²) (reference WB100036) depending on the format of the sample card to be stored. This packaging mode is even bulkier and more restrictive. The DNA sample thus preserved using the FTA® Elute method can be reused according to a three-step protocol:
1. cutting out the deposit zone using a hole punch with a generally cylindrical shape. This operation can be done manually or automatically using punching machines. However, this removal method using a hole punch does not make it possible to remove the entire surface area of the discolored zone, the shape of which may vary. It can thus be estimated that only 40% of the deposit zone can be removed in this way. This method is also a source of contamination between the samples through the successive use of a same punch to remove several different samples. To remove the entire deposit zone, one solution, but which is time-consuming and tedious, would be to cut out the entire deposit zone manually by adapting to its shape, using a sharp object such as a scalpel;
2. placing the DNA back in suspension in a buffer solution;
3. centrifuging to separate the support from the eluted DNA.

In the case of biological liquids such as blood or saliva deposited directly on an FTA® card, the DNA present is made available directly for molecular biology applications. The DNA sample can thus be reanalyzed with no intermediate step after cutting a fragment of the discolored zone of the card.

An alternative solution developed by GenTegra consists of offering a microplate with 384 positions, called GenPlate®, each of the 384 wells of which contains an FTA® paper disc with a diameter of 6 mm. This method avoids the step of punching the FTA® card as previously described and therefore eliminates the risk of contamination of the samples in this step. The preservation method consists of three steps:
depositing 10 μL of biological liquid (for example, blood) or 10 μL of a DNA solution on the FTA® paper disc;
drying for 12 to 16 hours at ambient temperature;
affixing a film to ensure the tightness of the samples.

The DNA sample thus preserved by the GenPlate® method can be reused according to a three-step protocol:
1. removing the FTA® paper disc from the well of the GenPlate® microplate: 100% of the deposit zone is used for the subsequent analysis of the sample, unlike the 40% of the protocol using the FTA® card;
2. placing the DNA back in solution in a buffer solution (GenSolve DNA COMPLETE™);
3. centrifuging in order to separate the support from the eluted DNA.

Due to the position of the FTA® discs in direct contact with the bottom of the well of the microplate, part of the biological liquid deposited on the disc passes through the paper and is transferred by contact with the bottom of the well. This drawback is even more critical given that the quantity of biological material deposited on the disc is already limiting to allow a new analysis of the sample.

In addition to the bulk constraint related to the storage modes, there is the constraint related to the archiving, which must make it possible to identify the location of one sample among the thousands, or even millions of others as quickly and simply as possible. At this time, the means used to identify the cards, the DNAshell® capsules or the DNAStable® or GenTegra® micro-tubes/microplates are “so-called passive” alphanumeric or 2D identifiers. Here, a passive identifier refers to an identifier that must be read individually and in visual contact or using a scanner, as opposed to an active identifier of the RFID (Radio Frequency Identification) chip type, which allows remote location of a sample or of several samples at once.

Regarding biological samples, and more specifically DNA samples taken in the criminology field, the practices of collecting the samples, called biological stains, must make it possible to keep a portion of the stain in question for subsequent or contradictory analyses (counter-analysis). Conversely, when the quantity of DNA present on the stain to be collected may prove insufficient to obtain a usable result, that is to say, between 50 and 100 picograms (pg) of DNA, the entire stain is then collected in order to maximize the success of the analysis. In this case, the only way to conduct a counter-analysis is to analyze the residual DNA, which must therefore be preserved under the best conditions so that it is not altered. Due to the development of biobanks, the democratization of DNA analyses, the exponential development of national genetic databases throughout the world and the different laws framing the preservation methods of biological stains for a new analysis, the need to preserve biological stains at the end of analyses, and more particularly the residual DNA, is estimated at several hundred thousand per year around the world.

Thus, there is currently a need for devices allowing the rapid storage of several thousands, if not millions of biological samples in a minimal space and with minimal logistical and technical constraints to allow their preservation over time, but also their individual reanalysis at a lower cost. In order to be fully effective, these devices must also make it possible to ensure traceability of the samples to be able to locate, transmit and analyze a sample of interest again, easily and quickly, without harming the preservation of the other samples.

Today, the Applicant is innovating in the storage and archiving of biological materials, by proposing a new device making it possible to meet these needs.

Indeed, the Applicant has developed a device for the ambient-temperature storage of biological material, comprising means making it possible to maintain the biological material, able to be contained in nonbiological substrates, above the bottom of the storage device, so as to prevent the transfer of biological materials present on these nonbiological substrates, with the bottom of the device. Said device is, in one particularly preferred embodiment according to the invention, covered by a lid made of the same material allowing tightness by simple pressure on the device, and contains a passive unique identifier of the 2D or 3D Datamatrix type and/or an active unique identifier of the RFID chip type. Furthermore, the integral assembly of 96, 384 or 1536 devices according to the invention and their archiving in a device described according to the invention allows a significant reduction in the necessary storage spaces.

Thus, according to a first object, the present invention relates to a device for the ambient-temperature storage of biological material, comprising a first container (1) formed by a base (5) and a side wall, said container (1) comprising, on its internal side wall, a means for maintaining a substrate above and separate from the base (5) of the container (1), said substrate being suitable for containing said biological material to be stored.

According to the present invention, “biological material” is meant to refer to any material derived from a living or deceased being, which may be in the form of molecules, organelles, fluids, cell fragments or cells, and present on a biological or nonbiological substrate.

Preferably according to the invention, said biological material to be stored contains nucleic acids, DNA and/or RNA.

Preferably according to the invention, said container (1) is cylindrical.

Preferably according to the invention, said container (1) has a volume inclusively between about 0.05 and about 0.5 cm³ corresponding at least to a cylindrical container with a diameter of 6.6 mm with a height of 1.5 mm.

Preferably according to the invention, said substrate able to contain said biological material to be stored is a synthetic or biological substrate.

“Biological substrate” refers to a biological sample, which may be derived from all or part of the living or deceased organism at the time of collection, for example derived from a mammal, preferably of human origin.

According to the present invention, “synthetic substrate” or nonbiological substrate refers to a nonliving surface, such as that of an object or an inert structure. This may involve all types of material such as materials made from textile fibers, cotton, histological sections of paraffin, nylon or cigarette paper. It may also involve reagents such as DNAStable®, DNAStable® LD, GenTegra-DNA® or any other types of reagents having identical or equivalent physicochemical properties in order to preserve DNA or RNA over time at ambient temperature in a dehydrated form. Furthermore, it may involve fragments of FTA® cards or other types of solid substrate having identical or equivalent physicochemical properties in order to preserve DNA or RNA over time at ambient temperature.

Preferably according to the invention, said container (1) is made from plastic or metal.

“Plastic” refers to a mixture containing a basic polymer capable of being molded in order to lead to a product or an object. This name contains three families of plastics, thermoplastics, thermosetting plastics and engineered plastics. The family of thermoplastics comprises different types of compounds such as acrylonitrile butadiene styrene (Afcoryl, Bayblend, Cycolac, Isopak, Lastilac, Lustran, Novodur, Polyflam, Polylac, Polyman, Fonfalin, Terluran, Toyolac, Ugikral, Vestodur), cellulose acetate (Cellidor A, Cellon, Lumarith, Rhodialite, Rhodoid, Setilitte, Trialithe), expanded polystyrenes (Afcolene, Depron, Hostapor, Polyfoam, Roofmate, Sagex, Styrocell, Styrodur, Styrofoam, Styropor, Vestypor), polyamides (Akulon, Altech, Amilan, Bergamid, Capron, DuraForm, Durethan, Eratlon, Ertalon, Grilamid, Grilon, Igamid, Kevlar, Latamid, Lauramid, Maranyl, Minion, Miramid, Nomex, Nylatron, nylon, Nypel, Orgamide, Perlon, Polyloy, Radiflam, Radilon, Renyl, Rilsan, Schulamid, Sniamid, Stanyl, Staramide, Starflam, Tactel, Technyl, Trogamid, Ultramid, Versamid, Vestamid, Vydyne, Zytel), polybutyleneterephthalates (Arnite, Celanex, Crastin, Deroton, Hostadur, Pocan, PTMT, Tenite, Ultradur, Vestodur), polycarbonates (Apec, Axxis, Durolon, Gerpalon, Latilon, Lexan, Makrolon, Panlite, Plaslube, Polyman, Sunglass, Tuffak, Xantar), polyethylenes (Alkathene, Alketh, Dyneema, Eltex, Hostalen, Lacqtene, Lupolen, Manolene, Marlex, Moplen, Plastazote, Polythen, Sclair, Stamylan, Stamylex, Supralen, Surlyn, Tupperware, Tyvek, Vestolen A), polyethylene terephthalates (Arnite, Baydur, Bidim, Dacron, Diolen, Ektar, Ertalyte, Hostadur K and A, Kodar, Melinex, Mylar, Pocan, Raditer, Rhodester, Rynite, Tenite, Tergal, Terphane, Terylene, Trevira, Ultradur), polymethylmethacrylates (Acrigel, Altuglas, Altulite, Bonoplex, Corian, Deglan, Limacryl, Lucite, Metacrilat, Oroglas, Perspex, Plexiglas, Resalit, Vitroflex), polyoxymethylenes (Acetaver, Bergaform, Celcon, Delrin, Ertacetal, Hostaform, Kematal, Kepital, Kocetal, Ultraform), polypropylenes (Amoco, Appryl, Carlona, Eltex, Hostalen PP, Luparen, Moplen, Novolen, Oleform, Polyflam, Profax, Propathene, Prylene, Stamylan P, Trovidur PP, Vestolen P), polystyrenes (Carinex, Edistir, Empera, Gedex, Hostyrene, Lacqrene, Luran, Lustran, Lustrex, Noryl, Polyflam, Polystyrene, Riviera, Styranex, Styroflex, Styron, Trolitul, Ursa, Vestyron), vinyl polyacetates (Elvacet, Hostaflex, Mowilith, Rhovyl, Vinnapas, Vinyon), polyvinyl chlorides (Benvic, Breon, Corfam, Darvic, Dynel, Garbel, Gedevyl, Hostalit, Lacovyl, Lacqvil, Lucolene, Lucovyl, Lucalor, Lucoflex, Micronyl, Mipolam, Nakan, Saran, Skai, Solvic, Tefanyl, Trovidur, Ultryl, Vestolit, Vinidur, Vinnol, Vinnolit, Vinoflex, Vinylite), styrene-acrylonitriles (Cifra, Elvan, Kostil, Lacqsan, Luran, Lustran, Restil, Tyril, Vestoran). The family of thermosets includes various types of compounds such as polyepoxides (Araldite, Devcon, DER, Doroxin, Epikote, Epon, Epotek, Epotuf, Epoxin, Eurepox, Lekutherm, Lopox, Rutapox), melamines (Arborite, Formica, Hostaset MF, Melochem, Melopas), phenoplasts (Bakelite, Cascophen, bakelized cloth, bakelized paper, bakelized wood, Fluosite, Hostaset PF, Luphen, Micarta, Peracite, Trolitan, Tufnol), polyurethanes (Baydur, Bayflex, Baygal, Cyanapren, Daltoflex, Definal, Desmodur, Desmolin, Estolan, Lupranat, Lupranol, Luvipren, Moltopren, Napiol, Scurane, Urepan, Voranol, Vulkolian, Vulkollan), aminoplasts (Aerodux, Beckamin, Cascamite, Hostaset UF, Pollopas, Prystal, Urochem) and polyesters (Hostaset UP, Leguval, Palatal, Pregmat, Ukapon, Vestopol). Finally, the family of engineering plastics essentially contains polytetrafluoroethylenes (Algoflon, Ertaflon, Fluon, Gaflon, Halon, Hostaflon, Polyflon, Soreflon, Teflon, Volta lef).

Preferably according to the invention, said means making it possible to maintain the substrate able to contain said biological material to be stored above and separate from the bottom (5) of the container (1) is a ring (3), preferably made from metal or plastic.

Preferably according to the invention, said ring (3) is molded with the container (1).

Preferably according to the invention, said substrate able to contain said biological material to be stored is selected from substrates made from material selected from textile fibers, plastics, paper, paraffin used for histological sections in the anatomy-pathology field, preferably paper chemically treated to allow the preservation over time and at ambient temperature of DNA extracted from a biological sample or contained in a biological sample.

“Textile fibers” refer both to natural and chemical textile fibers, whether the latter are artificial or synthetic. Thus, natural plant textile fibers comprise fibers of hemp, jute, kenaf, flax, lotus, nettle, ramie, Trichostigma octandrum, abaca, alfa grass, pineapple, asclepias, bamboo, Bromelia karatas, cotton, coir, New Zealand flax, kapok, papaya tree, papyrus, Sansevieria trifasciata, sisal and yucca. Natural animal textile fibers comprise fibers of alpaca, angora, cashmere, camel, wool, mohair, vicuna, yak, spider silk and silk. Natural mineral fibers also exist and comprise steel, stainless steel, silver, gold, and carbon and magnesium silicate. Lastly, natural inorganic fibers such as asbestos, basalt, carbon, quartz and glass also exist. Chemical fibers are obtained by chemical treatment of natural materials, and thus include cellulose acetate, alginate, ardil, arlan, casenka, coslan, cupro, fibrolane, lanital, merinova, polynosic, Silcool, cellulose triacetate, vicara and viscose. Synthetic fibers are obtained from synthetic materials, coming from the synthesis of chemical compounds. Synthetic fibers are separated into organic and inorganic synthetic fibers. Organic synthetic fibers include polylactic acid, polyamide, polyester, chlorofiber, acrylic, modacrylic, vinylic, elastodiene, vinylal, elasthane, (for example lycra), aramid, polybenzimidazole, polypropylene, polyethylene, polyphenolic, polyurea, polyurethane, and textilene. Synthetic inorganic fibers include fiberglass, ceramic, gold, silver, aluminum, carbon fiber and boron fiber.

“Paper” refers to the material manufactured from vegetable cellulosic fibers. This name refers to any type of paper including amine paper, Armenian paper, bulk paper, card stock, tracing paper, rag paper, rice paper, Chinese paper, cigarette paper, Korean paper, coated paper, crepe paper, letterhead, flash paper, ganpi paper, glassine paper, Japanese paper, Joseph paper, newsprint, kraft paper, lens paper, papier mäché marbled paper, graph paper, acid-free paper, bible paper, gummed paper, holland paper, wallpaper, stone paper, rice paper, tissue paper, parchment paper, toilet paper, torinokogami, litmus paper, vellum paper, laid paper, sandpaper, and Whatman paper.

Preferably and according to the invention, said biological material to be stored contains a nucleic acid, DNA or RNA, of animal origin, preferably human, plant, bacterial, plasmid, or viral.

Preferably according to the invention, said container (1) has a lid (2), preferably made from the same material as the container (1), making it possible to make the assembly airtight and watertight, said lid (2) preferably comprising a seal reinforcing the tightness.

“Seal reinforcing the tightness” refers to a device preventing fluid (liquid or gas) leaks between an inside environment and an outside environment, and which may be made from leather, oakum, fibrin, felt, rubber, elastomers, flexible synthetic polymers, or metal.

According to a second object, the present invention relates to a device for the ambient-temperature storage of biological material comprising an assembly (4) integral with at least 2, preferably a multiple of 8, more preferably 96, 384 or 1536 devices previously described according to the invention.

“Integral assembly” refers to a plurality of devices according to the invention, made integral with one another in order to form an assembly.

Preferably according to the invention, the containers (1) are connected to one another 2 by 2 by a sectile rod (6) making it possible to detach one or several containers (1) from the set.

“Sectile rod” refers to a rod making it possible to separate one or several devices from the set by cutting said rod, by pressure or using an object allowing them to be cut.

Preferably according to the invention, each of said containers (1) of the assembly (4) bears a lid (2) that is integral therewith making it possible to make each of said containers (1) of the assembly airtight and watertight, said lids (2) preferably being connected to one another two by two by sectile rods (6).

Preferably according to the invention, said lid (2) comprises a seal making a possible to strengthen the tightness of the container (1).

According to a third object, the present invention relates to a device for the ambient-temperature archiving of biological materials, able to accommodate at least 2 integral assemblies according to the invention, preferably between 2 and 50, still more preferably between 2 and 10, said archiving device being able to be opened or closed by a closure (8) making it airtight and watertight.

Preferably according to the invention, said archiving device comprises a system (9) making it possible to create a vacuum once it is closed.

Preferably according to the invention, said archiving device comprises guideways (10) making it possible to keep said assemblies (4) according to the invention in said archiving device.

Preferably according to the invention, each of said containers (1), assemblies (4) and/or archiving devices contains a passive unique identifier, preferably an identifier by high-density two- or three-dimensional barcode, of the 2D or 3D Datamatrix type, and/or an active unique identifier, preferably a chip based on the radiofrequency identification (RFID) technology.

According to a fourth object, the present invention relates to a method for storing biological material comprising the following steps:
a. Obtaining the biological material containing nucleic acid;
b. Arranging a substrate on the means making it possible to maintain said substrate above and separate from the bottom (5) of the container (1) in the storage device according to the invention;
c. Arranging, manually or using an automaton, the biological material on the substrate according to the invention.

Preferably according to the invention, said storage method also comprises a step d. for:
d. Closing the storage device according to the invention using said lid (2).

Preferably according to the invention, said storage method additionally comprises the following steps:
e. Inserting the storage device containing said biological material, or the assembly to which it belongs, in the archiving device according to the invention;
f. Closing said archiving device according to the invention.

Preferably according to the invention, said storage method also comprises a step g. for:
g. Creating a vacuum in the archiving device according to the invention.

According to a fifth object, the present invention relates to a method for unarchiving biological material comprising the following steps:
a. Determining what biological material is to be unarchived;
b. Identifying, using an active identifier reader, the location of said biological material to be unarchived via the active unique identifier according to the invention present on the archiving device in which it is archived;
c. Opening the archiving device according to the invention in which said biological material has been identified;
d. Identifying, using passive or active unique identifiers according to the invention, the assembly (4) containing said biological material to be unarchived;
e. Identifying, using passive or active unique identifiers according to the invention, said storage device containing said biological material to be unarchived;
f. Detaching the storage device containing said biological material to be unarchived by breaking the sectile rods (6), preferably by simple pressure or cutting;
g. Removing the biological material to be unarchived contained in said storage device manually or using an automaton.

Still other features and advantages of the invention will appear upon reading the following description of preferred, non-limiting embodiments of the invention in reference to the attached figures, in which:

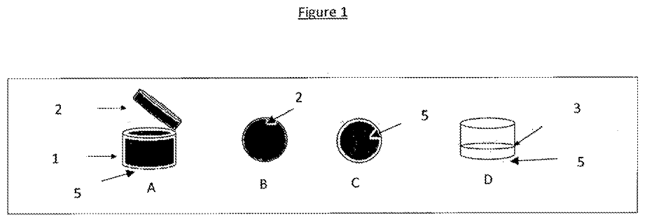

FIG. 1 shows the storage device according to the invention, in side view (A), in top view (B), in bottom view (C), and in interior side view (D);

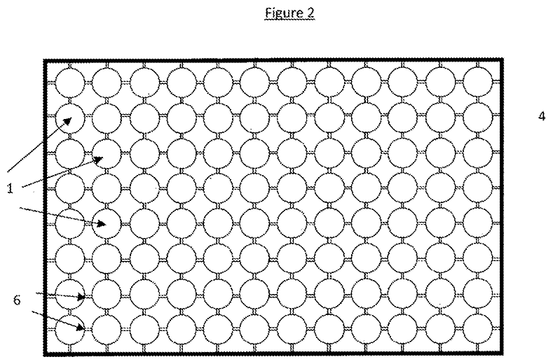

FIG. 2 shows an assembly of 96 storage devices according to the invention, in top view;

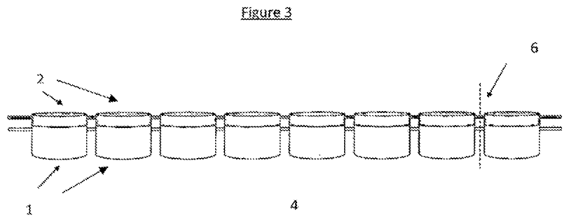

FIG. 3 shows an assembly of 96 storage devices according to the invention, in side view;

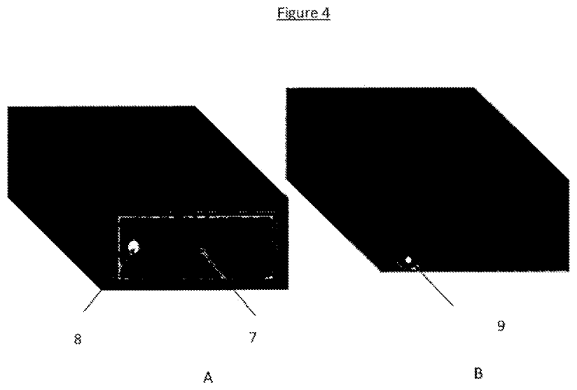

FIG. 4 shows the archiving device according to the invention in front view (A) and rear view (B);

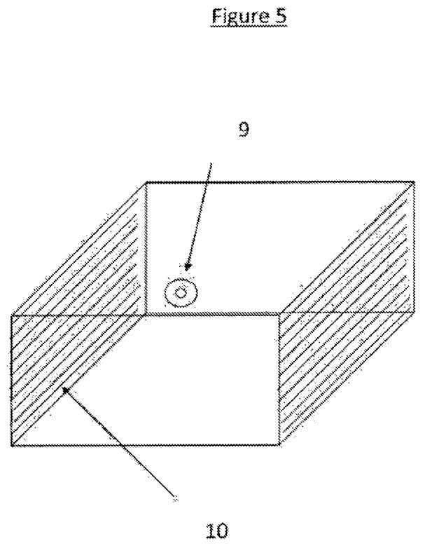

FIG. 5 shows the archiving device according to the invention in interior front view.

### EXAMPLE 1: ARCHIVING OF BIOLOGICAL MATERIAL

In reference to the figures, the storage device according to the invention comprises, as indicated in FIG. 1, a container 1, a lid 2, a means making it possible to maintain a substrate above and separate from the bottom (5) of the container (1), said substrate being able to contain said biological material to be stored, so as to prevent the transfer of biological materials with the bottom of the device. The use of this device consists of arranging, at the bottom of the container 1, which may be part of an assembly (4), for example of 96 containers (1) like in FIG. 2, a biological sample present on a substrate, which may for example be a reagent, such as the DNAStable®/DNAStable® LD or GenTegra-DNA® reagents, or an FTA® paper disc or an FTA® Elute (or equivalent) paper disc with an optimized diameter relative to the storage device according to the invention, and able to be maintained above the bottom of the device according to the invention by a substrate (3) that may for example assume the form of a ring, as shown in FIG. 1.

The biological material to be preserved is thus deposited manually or using an automaton on an FTA® paper disc positioned beforehand in a storage device according to the invention, present in an assembly of 96, on the means (3) according to the invention making it possible to maintain it above the bottom 5 of the container 1 of the device according to the invention. A set of lids (2) is next arranged manually or using an automaton on said containers (1) of the assembly (4), as illustrated in FIG. 3, making the assembly (4) of containers (1) of the storage device according to the invention integral and hermetically sealed, as illustrated in FIG. 3. This assembly (4) is thus stored in the archiving device immediately as illustrated in FIG. 4, by sliding it into the latter using the storage guideways (10) (FIG. 5), making it possible to optimize the classification of the assemblies (4) in the archiving device. The door (7) of this archiving device is next closed using the opening/closing system (8), making the archiving device airtight and watertight, as well as the assemblies (4), once the vacuum is created in the means (9) implemented according to the invention. In the version illustrated here, the archiving device thus makes it possible to store 960 samples (96*10) in an anhydrous and anoxic environment. In order to ensure the traceability of the archived biological material, each archiving device has a passive unique identifier of the 2D or 3D Datamatrix type as well as an active unique identifier of the RFID chip type. The storage and identification data are thus entered so as to be able to perform unarchiving when necessary, using an active identifier reader, without needing to open the other devices and risking damaging the stored biological material. In this configuration, it is thus possible to store about 924 storage devices per m² over a height of about 30 cm, or nearly 6,000,000 samples per 2 m³ (1 m² of floor space and 2 m high). Each of the assemblies and storage devices is also identified using a passive unique identifier of the 2D or 3D Datamatrix type and/or an active unique identifier of the RFID chip type, also making it possible to locate them very simply using an active identifier reader.

### EXAMPLE 2: UNARCHIVING OF BIOLOGICAL MATERIAL

When it is necessary to remove biological material from its archive, it is necessary to identify, using an active identifier reader, the location of said biological material to be unarchived using the active unique identifier present on the archiving devices according to the invention. Once the archiving device containing the biological material of interest has been identified, it is necessary to open said archiving device using the opening/closing system (8), and to identify, still using an active identifier reader, the assembly (4) containing the biological material of interest among all of the assemblies present in the archiving device. Next, the storage device (1) containing the biological material to be unarchived is identified, still using an active identifier reader, among the 96 storage devices (1) comprised in the assembly (4). Lastly, once said storage device (1) is identified, the latter is detached using sectile rods connecting it to the adjacent storage devices, by simple pressure or by cutting them. The storage device of interest is next opened, and its content is recovered manually or using an automaton.

1. A device for the ambient-temperature storage of biological material, comprising at least one container (1) formed by a base (5) and a side wall, characterized in that said container (1) comprises, on its internal side wall, a means for maintaining a substrate above and separate from the base (5) of the container (1), said substrate being suitable for containing said biological material to be stored.

2. The device according to claim 1, characterized in that said biological material to be stored contains nucleic acids, DNA and/or RNA.

3. The device according to one of claims 1 and 2, characterized in that said container (1) is cylindrical.

4. The device according to one of claims 1 to 3, characterized in that said substrate able to contain said biological material to be stored is a synthetic or biological substrate.

5. The device according to one of claims 1 and 4, characterized in that said container (1) is made from plastic or metal.

6. The device according to one of claims 1 to 5, characterized in that said means making it possible to maintain the substrate able to contain said biological material to be stored above and separate from the bottom (5) of the container (1) is a ring (3), preferably made from metal or plastic.

7. The device according to claim 6, characterized in that said ring (3) is molded with the container (1).

8. The device according to the preceding claims, characterized in that the substrate able to contain said biological material to be stored is selected from substrates made from material selected from textile fibers, plastics, paper, paraffin used for histological sections in the anatomy-pathology field, preferably paper chemically treated to allow the preservation over time and at ambient temperature of DNA extracted from a biological sample or contained in a biological sample.

9. The device according to one of claims 1 and 8, characterized in that said biological material to be stored contains a nucleic acid, DNA or RNA, of animal origin, preferably human, plant, bacterial, plasmid, or viral.

10. The device according to one of claims 1 to 9, characterized in that said container (1) has a lid (2), preferably made from the same material as the container (1), making it possible to make the assembly airtight and watertight, said lid (2) preferably comprising a seal reinforcing the tightness.

11. A device for the ambient-temperature storage of biological material comprising an assembly (4) integral with at least 2, preferably a multiple of 8, more preferably 96, 384 or 1536 devices according to one of claims 1 and 10.

12. The device according to claim 11, characterized in that the containers (1) are connected to one another 2 by 2 by a sectile rod (6) making it possible to detach one or several containers (1) from the set.

13. The device according to claim 11 or 12, characterized in that each of said containers (1) of the assembly (4) bears a lid (2) that is integral therewith making it possible to make each of said containers (1) of the assembly (4) airtight and watertight, said lids (2) preferably being connected to one another two by two by sectile rods (6).

14. The device according to claim 13, characterized in that said lid (2) comprises a seal making it possible to strengthen the tightness of the container (1).

15. A device for the ambient-temperature archiving of biological materials, characterized in that it is able to accommodate at least 2 devices according to one of claims 11 to 14, preferably between 2 and 50, still more preferably between 2 and 10, said archiving device being able to be opened or closed by a closure (8) making it airtight and watertight.

16. The archiving device according to claim 15, characterized in that it comprises a system (9) making it possible to create a vacuum once it is closed.

17. The device according to claims 1 to 16, characterized in that each of said containers (1), assemblies (4) and/or archiving devices contains a passive unique identifier, preferably an identifier by high-density two- or three-dimensional barcode, of the 2D or 3D Datamatrix type, and/or an active unique identifier, preferably a chip based on the radiofrequency identification (RFID) technology.

18. A method for storing biological material comprising the following steps:
a. Arranging a substrate on the means making it possible to maintain said substrate above and separate from the bottom (5) of the container (1) in the storage device according to one of claims 1 to 14 and 17.
b. Arranging, manually or using an automaton, the biological material on the substrate according one of claims 1 to 14 and 17;

19. The method for storing biological material according to the preceding claim, also comprising the following step c:
c. Closing the storage device according to one of claims 10 to 14 and 17 using said lid (2).

20. The method for storing biological material according to the preceding claim, also comprising the following steps:
d. Inserting the storage device containing said biological material, or the assembly (4) to which it belongs, in the archiving device according to one of claims 15 to 17;
e. Closing said archiving device according to one of claims 15 to 17.

21. The method for storing biological material according to the preceding claim, also comprises a step f. for:
f. Creating a vacuum in the archiving device according to one of claims 16 and 17.

22. A method for unarchiving biological material, comprising the following steps:
a. Determining what biological material is to be unarchived;
b. Identifying, using an active identifier reader, the location of said biological material to be unarchived via the active unique identifier according to claim 17 present on the archiving device in which it is archived;
c. Opening the archiving device according to claims 15 to 17 in which said biological material has been identified;
d. Identifying, using passive or active unique identifiers according to claim 17, the assembly (4) containing said biological material to be unarchived;
e. Identifying, using passive or active unique identifiers according to claim 17, said storage device containing said biological material to be unarchived;
f. Detaching the storage device containing said biological material to be unarchived by breaking the sectile rods (6), preferably by simple pressure or cutting;
g. Removing the biological material to be unarchived contained in said storage device manually or using an automaton.
